(19) United States
(12) Patent Application Publication
(10) Pub. No.: US 2009/0269854 A1
(43) Pub. Date: Oct. 29, 2009

(54) MICROCHIP

(75) Inventor: Yasuhisa Kageyama, Kyoto (JP)

Correspondence Address: GLOBAL IP COUNSELORS, LLP, 1233 20TH STREET, NW, SUITE 700, WASHINGTON, DC, 20036-2680, US

(73) Assignee: Rohm Co., Ltd., Kyoto-shi (JP)

(21) Appl. No.: 12/096,334

(22) PCT Filed: Dec. 4, 2006
(86) PCT No.: PCT/JP2006/324608

§ 371 Date: Jun. 5, 2008

(30) Foreign Application Priority Data
Dec. 5, 2005 (JP) 2005-350585

(51) Int. Cl. G01N 1/18; G01N 9/30

(52) U.S. Cl. 436/177; 422/72

(57) ABSTRACT

The capture rate of a target such as antigen and antibody in a sample is improved and the concentration of reaction product of a recognition substance is uniformized regardless of the position of a reaction field. By contacting microparticles and the sample using centrifugal force, the contact time of the target and the recognition substance is equalized regardless of the position in mixing chamber The microparticles and the sample are mixed evenly in the mixing chamber by changing the rotation direction and the concentration of reactant in a liquid mixture is uniform regardless of the position of the mixing chamber. When the liquid mixture having a uniform concentration is obtained, it is enough to extract a part of the liquid mixture and use the same for a process subsequent to a mixing process without the need of using all the liquid mixture.

### TECHNICAL FIELD

The present invention relates to a method for using a microchip, a microchannel and a microchip. It also relates to a microchannel used for separating, mixing and detecting a biomaterial substance, a method for using a microchip having the same, a microchannel and a microchip.

### BACKGROUND ART

Patent Document 1 discloses an immuno analyzer that aims to enable an easy and high-precision immuno analysis in a short time with a small quantity of sample. FIG. 7 is a perspective view showing a configuration of this immuno analyzer. A solution introduced from an introduction part 105 of an immuno analyzer 101 reacts with microparticles 102 immobilized to a reaction field 103.

### [Patent Document 1] Japanese Patent Laid-open No. 2001-004628

### SUMMARY OF THE INVENTION

However, it can be assumed that a pump is used for contacting the solution with the microparticles 102 for the immuno analyzer of Patent Document 1. It is because this immuno analyzer 101 does not have a configuration that enables a centrifugal operation. However, it is difficult to keep the flow rate constant by pumping a fluid regardless of the position of a channel. This becomes prominent when the flow rate is low or the solution passes through some kind of junction. As a result, an antigen and antibody in the solution cannot securely be captured, thus the contact time of the solution such as a sample with the microparticles is varied depending on the position of the reaction field 103, which results in an ununiform concentration of reactant produced by an antigen-antibody reaction in the reaction field 103.

FIG. 8 shows photographs showing an experimental example when an ink fluid and microparticles to which a recognition substance, that reacts with a target in a sample is immobilized are contacted by sending the fluid by a pump. The sample solution introduced into a chamber T as a reaction field via an introduction inlet M of the chamber T is flowed into a pump inlet Q from the introduction inlet M by the pump attached to the pump inlet Q. The reaction is caused between the target and the recognition substance, by the sample solution contacting with the microparticles in the chamber T on the way to the pump inlet Q. The concentration of the target is indicated by the change in color of the microparticles in the chamber T. As the pump sends the sample solution, the target spreads in the chamber T with the introduction inlet M as the center. However, the concentration is higher near the introduction inlet M, and the concentration becomes lower as it gets further from the introduction inlet M. At the corners of the chamber, the target is almost invisible.

As FIG. 8 shows, when the fluid is sent to the reaction field by the pump, the reaction between the target and the recognition substance becomes ununiform in the reaction field. This makes it difficult to partially extract the reaction solution produced in the reaction field and to use it for a subsequent treatment. In order to prevent the ununiform concentration in the reaction field from affecting a subsequent treatment, it is necessary that all the reaction solution in the reaction field is used for a subsequent treatment. For this reason, it is difficult to reduce the amount of sample and reagent in each part subsequent to the reaction field, such as a detection part and a mixing chamber, thus a problem whereby it is difficult to reduce the size of the microchip itself exists.

An object of the present invention is to improve the capture rate of a target and the like such as antigen and antibody in a sample, and to uniformize the concentration of substance existing in a solution regardless of the position of a reaction field.

A first aspect of the present invention provides a microchip for treating a sample using centrifugal force. The microchip comprises:

a mixing chamber for mixing microparticles and the sample,
the miciroparticles being prepared by immobilizing a first recognition substance or a second recognition substance to a granular carrier,
   the first recognition substance recognizing a target in the sample, and
   the second recognition substance recognizing the first recognition substance; and

a microchannel connected to the mixing chamber,

wherein the mixing chamber holds the microparticles in a way that the microparticles are flowable.

In this microchip, the mixing chamber holds the microparticles in a way that they can flow.

By contacting the microparticles and the sample using centrifugal force, the contact time of the target with the first recognition substance or the contact time of the first recognition substance with the second recognition substance will be equalized regardless of the position in the mixing chamber. Further, because the microparticles and the sample are mixed in the mixing chamber evenly by changing the rotation direction, the concentration of the reactant in the liquid mixture will be uniform regardless of the position of the mixing chamber.

When the liquid mixture having the uniform concentration as mentioned above can be obtained, it is sufficient to extract only a part of the liquid mixture and use it without the need to use all of the liquid mixture. Therefore, the amount of solution introduced into a part used for a process subsequent to the mixing process can be reduced, and the whole microchip can be miniaturized. For example, parts used for a process subsequent to the mixing process may be a second mixing chamber and a detection part. Also, when a further channel for mixing is provided in the downstream of the mixing chamber, the whole microchip can be miniaturized by shortening or omitting that channel.

The microparticles are held in the mixing chamber in advance. The microparticles in the mixing chamber may be a granular carrier to which the first recognition substance or the second recognition substance is immobilized, or may be a granular carrier to which the first recognition substance or the second recognition substance is not immobilized. In the latter case, by introducing a reagent containing the first recognition substance or the second recognition substance into the mixing chamber, the first recognition substance or the second recognition substance is immobilized to the granular carrier inside the mixing chamber to produce the microparticles. Thereafter, by contacting the produced microparticles and the sample using centrifugal force, the target in the sample can be recognized by the first recognition substance, or the first recognition substance by the second recognition substance.

In the microchip, a diameter of the microchannel at a connection part of the microchannel to the mixing chamber is preferably formed greater than a diameter of the microparticles in the mixing chamber. The microchip preferably further comprises an outflow prevention pillar for preventing the microparticles from flowing out from the mixing chamber. The outflow prevention pillar is preferably formed at the connection part.

When the minimum diameter of the microchannel is greater than the diameter of the microparticles, by providing the outflow prevention pillar, the microparticles are prevented from flowing out from the mixing chamber to outside while the microchip is transported and the like. Because the diameter of the microchannel can be designed to be larger by providing the outflow prevention pillar, it will become easier to manufacture the microchip itself.

In the microchip, a diameter of the microchannel at a connection part of the microchannel to the mixing chamber is preferably formed smaller than the diameter of the microparticles.

When the minimum diameter of the microchannel is smaller than the diameter of the microparticles, the microparticles are prevented from flowing out from the mixing chamber to outside while the microchip is transported and the like.

In the microchip, a part of a wall surface of the mixing chamber is preferably curved along a predetermined rotation direction.

When the wall surface of the mixing chamber is formed along the rotation direction, a content of the mixing chamber moves along the curved wall more easily when the microchip is rotated along the rotation direction. Thus, it becomes easier to mix the microparticles and the sample evenly.

When the microchip is rotated with two or more rotation axes as the center, the mixing chamber preferably has a curved surface along each of the rotation directions. By rotating along different rotation directions, the content will be mixed more easily in each rotation. As a result, it becomes easier to further uniformize the concentration of the liquid mixture.

In the microchip, the microchannel is preferably connected to a wall surface at a point other than where a pressure of a content in the mixing chamber is received when mixing is carried out therein.

The microchannel is preferably connected to the wall surface where the pressure of the liquid mixture in the mixing chamber is not received during the mixing process therein. For example, the microchannel is connected to the wall surface opposite to the wall surface where the pressure of the liquid mixture is received during the mixing process. This makes it easier to prevent the liquid mixture from flowing out from the microchannel for introducing the sample into the mixing chamber or from the microchannel for ejecting the liquid mixture for a subsequent process to outside the mixing chamber.

In the microchip, the microchannel is preferably connected at a position in a way that a liquid mixture in the mixing chamber does not leak when the microchip is rotated in a predetermined first rotation direction and a predetermined second direction.

Practically, it is necessary to rotate the microchip at least in two directions when the microparticles and the sample in the mixing chamber are to be mixed by the rotation. It is because the concentration of the liquid mixture cannot be uniformized only by the rotation in one direction, which only causes centrifugal force in one direction. Therefore, the connection part of the microchannel is provided at the position such that the liquid mixture does not leak when the microchip is rotated in the first rotation direction and the second rotation direction. Note that there may be three or more rotation axes for the microchip.

In the microchip, the granular carrier is preferably polysaccharide-based granular gel, latex particles or magnetic beads.

Polysaccharide-based granular gel, for example Chitopearl® (manufactured by FUJIBO HOLDINGS, INC.), has enough strength not to be destroyed in the rotation in addition to a function as a carrier for immobilizing antigen, antibody, enzyme, etc. thereto. Thus, it is preferably used as the granular carrier for the present invention.

Another aspect of the present invention provides a method of using the microchip according to the first aspect of the present invention. The method comprises the step of mixing the microparticles and the sample in the mixing chamber by rotating the microchip in a first rotation direction and thereafter by rotating the microchip in a second rotation direction that is different from the first rotation direction.

The sample introduced into the mixing chamber and the microparticles to which a recognition substance is immobilized are mixed by the rotation in two directions. Contact time of the recognition substance with the sample will be more or less equalized regardless of the position of the mixing chamber. Furthermore, because the microchip is rotated at least in two different rotation directions, the concentration of the liquid mixture of the microparticles and the sample can be uniformized regardless of the position in the mixing chamber.

The method preferably further comprises the steps of:

ejecting a part of a liquid mixture in the mixing chamber through any of microchannels by rotating the microchip in a third rotation direction that is different from the first rotation direction or the second rotation direction, and

analyzing a target in the sample using the part of the liquid mixture ejected in the step of ejecting.

Because the concentration of the liquid mixture obtained by Invention 8 is uniform regardless of the position of the mixing chamber, a subsequent process can be carried out simply by extracting a part of the liquid mixture in the mixing chamber. Thus, the amount of reagent needed for a subsequent process can be reduced.

The method preferably further comprises the step of repeating the step of mixing.

By repeating the rotation in different directions, the uniformity of the concentration of the liquid mixture will be enhanced.

In the method, the first rotation direction and the second rotation direction are adjusted so that a connection part of the microchannel to the mixing chamber is not included on a wall surface against which the liquid mixture in the mixing chamber is pushed by centrifugal force in the step of mixing.

The rotation direction is adjusted when the mixing is carried out so that the liquid mixture does not leak from the microchannel to outside. In this way, the solution in the mixing chamber can be mixed by turning force used for centrifuging and the like.

By using the microchip of the present invention, the contact time of the target with the first recognition substance, or the contact time of the first recognition substance with the second recognition substance will be equalized irrespective of the position in the mixing chamber by contacting the microparticles and the sample using centrifugal force. Furthermore, because the microparticles and the sample are mixed evenly in the mixing chamber by changing the rotation direction, the concentration of reactant in the liquid mixture will be uniformized irrespective of the position of the mixing chamber.

### BRIEF DESCRIPTION OF THE DRAWINGS

FIG. 1 is a plan view showing one embodiment of a microchip of the present invention;

FIG. 2 is an explanatory diagram showing a treatment process (1) using the microchip of the present invention;

FIG. 3 is an explanatory diagram showing a treatment process (2) using the microchip of the present invention;

FIG. 4 is a plan view showing a series of movements for explaining a method for using the microchip of the present invention;

FIG. 5 shows plan photographs showing a series of movements in an experimental example of a method for using the microchip of the present invention;

FIG. 6 is a plan view of a microchip according to a second embodiment;

FIG. 7 is a perspective view showing a configuration of a conventional microchip; and

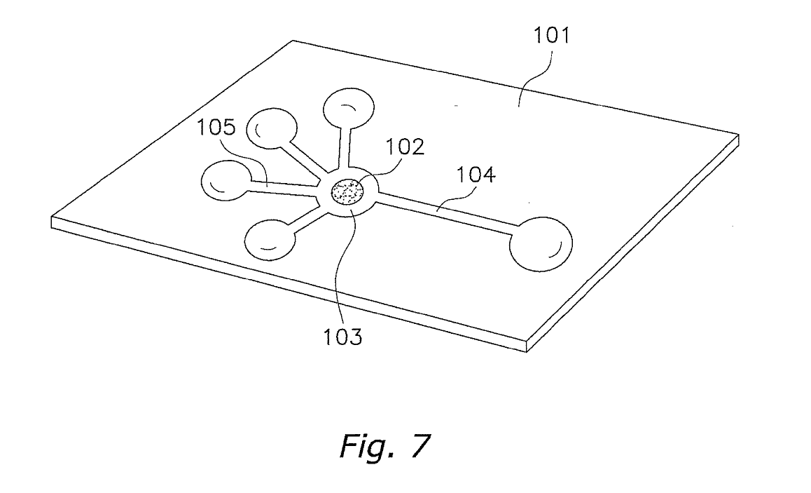

FIG. 8 shows plan photographs explaining a method for using the conventional microchip.

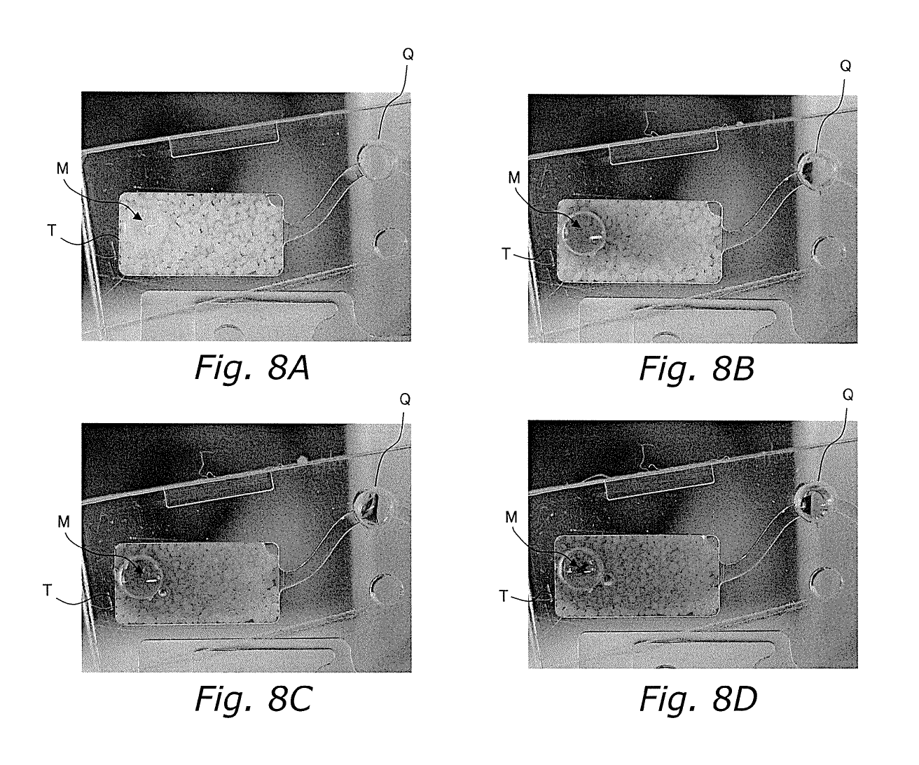

### BEST MODE FOR IMPLEMENTING THE INVENTION

### First Embodiment

### (1) Overall Configuration of Microchip

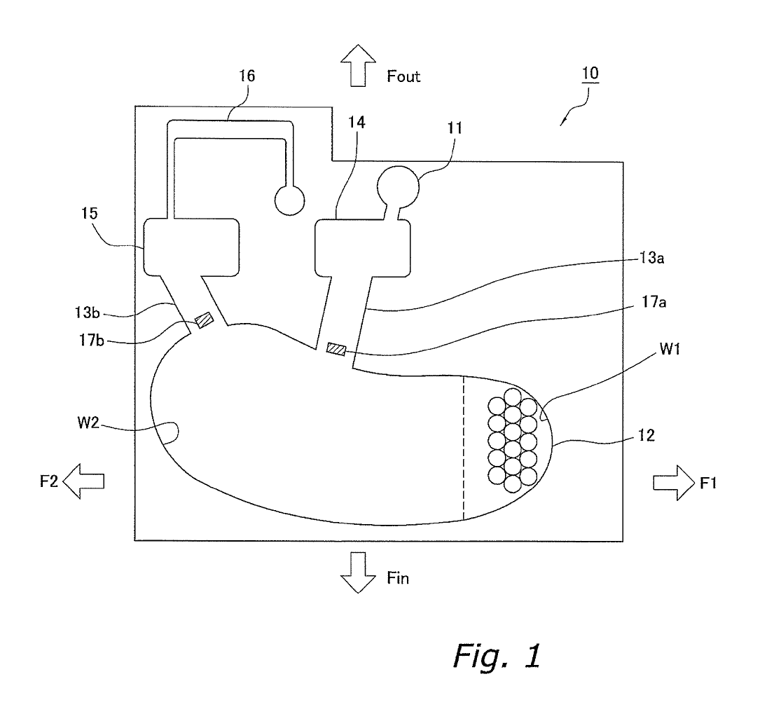

FIG. 1 is a plan view of a microchip according to a first embodiment. The microchip of the present invention is a microchip based on an assumption that it does not use a pump but uses centrifugal force for moving a solution in a process of mixing a substance, that recognizes a target in a sample, and microparticles.

A microchip 10 in FIG. 1 has the following elements.

### (a) Sample Introduction Part

A sample introduction part 11 introduces a sample into the microchip 10 from outside. The sample introduction part 11 may also have a function for temporarily holding the introduced sample.

### (b) Mixing Chamber

A mixing chamber 12 holds a granular carrier to which a recognition substance is immobilized (hereinafter referred to as microparticles) or a granular carrier before a recognition substance is immobilized thereto in a way that they can flow. The mixing chamber 12 is a space in which at least the sample and the microparticles are mixed. In some cases, a reagent is also mixed. A recognition substance to be immobilized is a first recognition substance that reacts with a target in the sample, or a second recognition substance that reacts with the first recognition substance. For example, each of a combination of the target and the first recognition substance, and a combination of the first recognition substance and the second recognition substance is at least one combination selected from the group consisting of enzyme-substrate, coenzyme-enzyme, antigen-antibody, ligand-receptor, DNA-DNA, DNA-RNA, RNA-RNA, PNA-DNA and PNA-RNA. The details of the mixing chamber 12 will be explained later.

### (c) Microchannel

Microchannels 13a and 13b (hereinafter collectively referred to as microchannels 13) are connected to the mixing chamber 12, and they introduce the sample and the reagent into the mixing chamber 12, eject the liquid mixture in the mixing chamber to outside and the like. The diameter of the microchannels 13 at the connection parts to the mixing chamber 12 is formed greater than that of the microparticles in the mixing chamber 12. Note, however, that outflow prevention pillars 17a and 17b are formed in the connection parts. Gaps formed by the outflow prevention pillars 17a and 17b in the microchannels 13 are adjusted in a manner such that they are smaller than the diameter of the microparticles. In this way, the microparticles in the mixing chamber 12 are prevented from flowing into the microchannels 13 irrespective of the rotation direction applied to the microchip 10.

A plurality of outflow prevention pillars 17a and 17b may be provided for each of the microchannels 13a and 13b. In such a case, gaps formed by the outflow prevention pillars 17a and 17b are adjusted so as not to exceed the diameter of the microparticles.

### (d) Preliminary Mixing Chamber

A preliminary mixing chamber 14 is a space provided between the sample introduction part II and the mixing chamber 12. The preliminary mixing chamber 14 holds the reagent. The sample introduced from the sample introduction part 11 and the reagent are mixed in the preliminary mixing chamber 14. The mixture of the sample and reagent moves to the mixing chamber 12 through the microchannel 13a. For example, the reagent held in the preliminary mixing chamber 14 is an enzyme-labeled antibody as the first recognition substance. The enzyme-labeled antibody reacts with the target in the sample. Further, the enzyme-labeled antibody promotes the color reaction by the activity of the enzyme. The size and shape of the preliminary mixing chamber 14 are not particularly limited. For example, the preliminary mixing chamber 14 has a volume of about 10 to 30 μL.

### (e) Colorimetric Reaction Part

A calorimetric reaction part 15 is a space in which a reagent is held. The liquid mixture introduced from the mixing chamber 12 to the calorimetric reaction part 15 and the reagent in the calorimetric reaction part 15 are further mixed. A substance that reacts with a labeled substance such as an enzyme contained in the liquid mixture and develops a predetermined color is chosen as the reagent. In the present invention, because the concentration of the liquid mixture in the mixing chamber 12 is uniform and there is no need to send the total amount of the mixture to the colorimetric reaction part 15, the volume of the calorimetric reaction part 15 and the amount of the reagent to be held can be reduced. The size and shape of the calorimetric reaction part 15 are not particularly limited, but it has a volume of about 10 to 100 μL, for example.

### (f) Detection Part

A reacting substance that has developed a predetermined color in the calorimetric reaction part 15 is introduced into a detection part 16. The concentration and amount of the color reacting substance introduced into the detection part 16 is detected by a predetermined detection method. An optical method is commonly used as the detection method. When the optical detection method is used, an entrance of the light, a light path and an exit of the light are formed in the detection part 16 so that the light is irradiated inside thereof to enable its reflected light, transmitted light and scattered light to be detected. For example, the detection part 16 has a constant shape with the length of about 10 mm and the cross-sectional area of about 0.25 to 1 mm².

### (2) Mixing Chamber

### (2-1) Shape of Mixing Chamber

A part of the wall surface of the mixing chamber 12 is curved along a predetermined rotation direction. When the wall surface of the mixing chamber 12 is formed along its rotation direction, the mixing of the microparticles and the sample is prompted, thus making it easier to uniformize the concentration of reactant in the liquid mixture.

The microchip 10 of the present invention is rotated in two or more different rotation directions (hereinafter referred to as a first rotation direction and a second rotation direction) and the microparticles and the sample in the mixing chamber 12 are mixed. The microchip 10 is rotated in more than two different rotation directions because the rotation in only one direction is not sufficient to uniformize the concentration of the liquid mixture when the mixing of the microparticles and the sample in the mixing chamber 12 is to be carried out by rotating the microchip 10. Therefore, the mixing chamber 12 preferably has a curved surface W1 along the first rotation direction and a curved surface W2 along the second rotation direction. This prompts the mixing of the microparticles and the sample, thereby improving the uniformity of the concentration of the liquid mixture.

The mixing is prompted more easily when the angle formed by centrifugal force F1 caused by the rotation in the first rotation direction and centrifugal force F2 caused by the rotation in the second rotation is closer to 180 degrees. However, the mixing may be carried out with a narrower angle, for example, an angle of 90 degrees. However, it is preferable that the curved surfaces W1 and W2 are in smooth continuity. It is because the microparticles are easier to move along the inside wall of the mixing chamber 12 when the rotation direction changes.

### (2-2) Connection of Mixing Chamber and Microchannel

The microchannels 13 are connected to the wall surface at points other than where the pressure of the content in the mixing chamber 12 is received when the mixing is carried out therein. In other words, the microchannels 13 are connected at positions in a way that the liquid mixture in the mixing chamber 12 does not leak when the microchip 10 is rotated in the aforementioned first rotation direction and second rotation direction. In this example, the microchannels 13 are connected on a surface other than the curved surfaces W1 and W2.

In this way, it becomes easier to prevent the liquid mixture from flowing out from the microchannel 13a that introduces the sample into the mixing chamber 12 and from the microchannel 13b that ejects the liquid mixture to the colorimetric reaction part 15, to outside the mixing chamber 12.

Note that the microchannel 13a connects the preliminary mixing chamber 14 and the mixing chamber 12 at the position and in the direction in a way that the fluid is introduced inside the mixing chamber 12 from the preliminary mixing chamber 14 by centrifugal force acting in a direction indicated by the arrow Fin in the figure when the microchip 10 is rotated in a predetermined third rotation direction. In this way, the fluid in the preliminary mixing chamber 14 is introduced into the mixing chamber 12 through the microchamiel 13a.

Also, the microchannel 13b is connected at the position and in the direction in a way that the liquid mixture in the mixing chamber 12 can flow by centrifugal force acting in a direction indicated by the arrow Fout in the figure when the microchip 10 is rotated in a predetermined fourth rotation direction. In this way, the liquid mixture is introduced into the calorimetric reaction part 15 through the microchannel 13b.

### (2-3) Granular Carrier in Mixing Chamber

Granular carrier is held in the mixing chamber 12 in advance. The first recognition substance or the second recognition substance may be immobilized to the granular carrier in advance, or may not be immobilized. In the latter case, prior to introducing the sample into the mixing chamber 12, the reagent containing the first recognition substance or the second recognition substance is introduced into the mixing chamber 12. In this way, the first recognition substance or the second recognition substance is immobilized to the granular carrier in the mixing chamber 12 to produce the microparticles. Subsequently, the sample is introduced into the mixing chamber 12, and the target in the sample can be recognized by the first recognition substance, or the first recognition substance can be recognized by the second recognition substance by contacting the produced microparticles and the sample using centrifugal force.

Preferably, particles having a tendency to form a covalent bond with the first recognition substance or the second recognition substance are used for the granular carrier to which the first recognition substance or the second recognition substance is immobilized. Preferably, the diameter of the granular carrier does not exceed a few hundreds μm. In addition, the granular carrier preferably has enough strength so that it is not destroyed in the mixing chamber 12 when the microchip 10 is centrifuged. Examples of the granular carrier that meet such a condition may be polysaccharide-based granular gel, latex particles and magnetic beads.

A preferable example of the polysaccharide-based granular gel may be Chitopearle (manufactured by FUJIBO HOLDINGS, INC.). When Chitopearl is used as the granular carrier, a buffer solution is held in the mixing chamber 12, which prevents Chitopearl from drying. The total volume of Chitopearl and the buffer solution is about 16 μL, for example, and the volume occupied by Chitopearl in the total volume is about 10 μL.

Examples of the magnetic beads may be Fe₃O₄, γ-Fe₂O₃, Co-γ-Fe₂O₃, (NiCuZn)O.Fe₂O₃, (CuZn)O.Fe₂O₃, (Mn.Zn)O.Fe₂O₃, (NiZn)O.Fe₂O₃, SrO.6Fe₂O₃, BaO.6Fe₂O₃, and Fe₂O₃ coated with SiO₂, composite microparticles of various high polymer materials (nylon, polyacrylamide, protein, etc.) and ferrite, magnetic metal microparticles, etc.

Note that the arrangement, the number and the shape of each functional part is not limited to the aforementioned examples. For example, the arrangement and the shape of each functional part included from the sample introduction part 11 to the mixing chamber 12, and the arrangement and the shape of each functional part included from the mixing chamber 12 to the detection part 16 may be modified as needed.

### (3) Reaction Process in Microchip

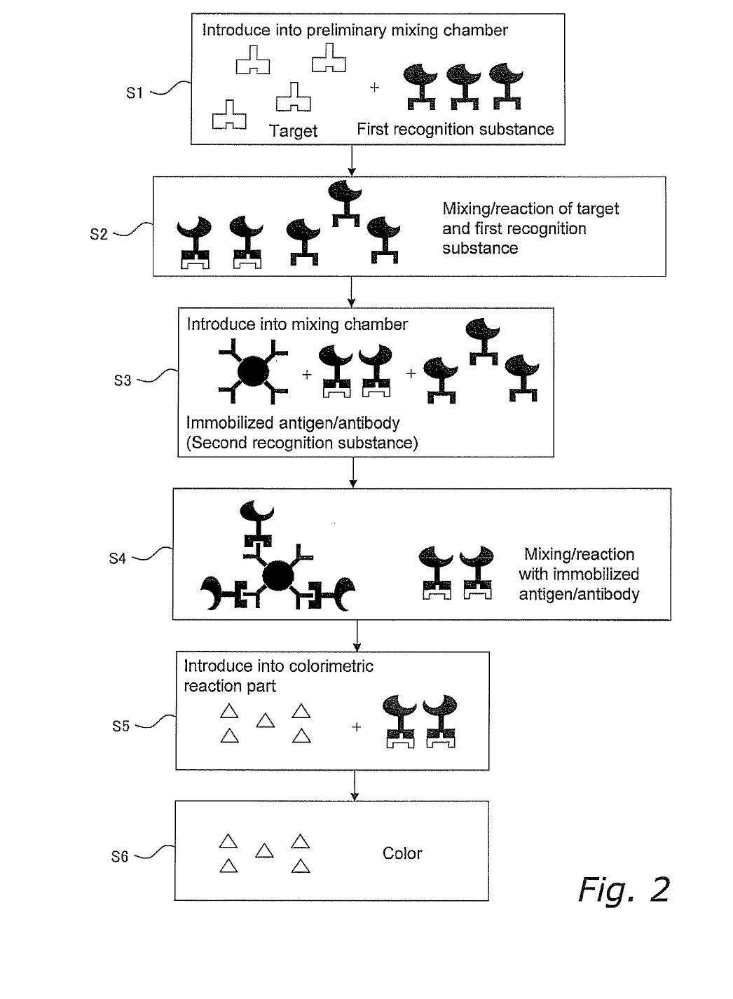

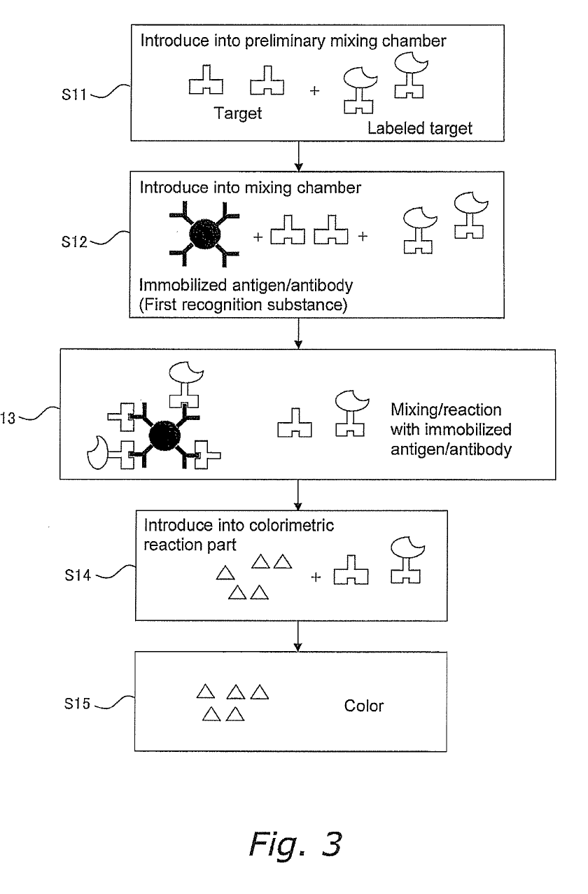

Now, referring to FIG. 2 and FIG. 3, a flow of reaction process in the microchip 10 of FIG. 1 will be explained.

FIG. 2 shows a treatment process of a case where a labeled antibody as the first recognition substance is held in the preliminary mixing chamber 14, and the microparticles to which the second recognition substance is immobilized is held in the mixing chamber 12. In the figure, an immobilized antigen/antibody which shows antigen-antibody reaction with the first recognition substance is considered as the second recognition substance.

First, the target is introduced into the preliminary mixing chamber 14 from the sample introduction part 11 (S1), and the target and the first recognition substance are mixed and reacted in the preliminary mixing chamber 14 (S2). Thereafter, the reaction solution is introduced into the mixing chamber 12 (S3), and the immobilized antigen/antibody, the reacting substance of the target and the first recognition substance, and the first recognition substance are mixed (S4). In this way, the first recognition substance and the immobilized antigen/antibody are reacted, and the first recognition substance is captured by the microparticles. The first recognition substance captured by the microparticles remains in the mixing chamber 12. On the other hand, the target reacted with the first recognition substance is introduced into the calorimetric reaction part 15 without being captured by the microparticles, and what is referred to as B/F separation is carried out (S5). Thereafter, the reacting substance of the labeled antibody and the target which is introduced into the colorimetric reaction part 15 is mixed with a color substance, and a color is developed by the activity of HRP in the labeled antibody. For example, the liquid mixture that has developed the color is measured for its absorbance, and the target in the sample can be quantified by converting the obtained result.

FIG. 3 shows a treatment process of a case where a labeled target is held in the preliminary mixing chamber 14, and the microparticles to which a first recognition substance is immobilized are held in the mixing chamber 12. In the figure, an immobilized antigen/antibody which shows antigen-antibody reaction with a target is considered as the first recognition substance.

First, the target is introduced into the preliminary mixing chamber 14 from the sample introduction part 11, and the target and the labeled target are mixed in the preliminary mixing chamber 14 (S11). Subsequently, the liquid mixture is introduced into the mixing chamber 12 (S12), and the immobilized antigen/antibody, the target and the labeled target are mixed (S13). In this way, the target and the labeled target, and the immobilized antigen/antibody are reacted, and a part of the target and the labeled target are captured by the microparticles. The target and the labeled target captured by the microparticles remain in the mixing chamber 12. On the other hand, the remaining target and labeled target are introduced into the colorimetric reaction part 15 without being captured by the microparticles, and what is referred to as B/F separation is carried out (S14). Thereafter, the labeled target and the target introduced into the calorimetric reaction part 15 are mixed with a color substance, and a color is developed by the activity of HRP in the labeled target. For example, the liquid mixture that has developed the color is measured for its absorbance, and the labeled target can be quantified by converting the obtained result. It is possible to quantify the target from the ratio of the labeled target and the sample that were used first, and the amount of the quantified labeled target.

### (4) Method for Using Microchip

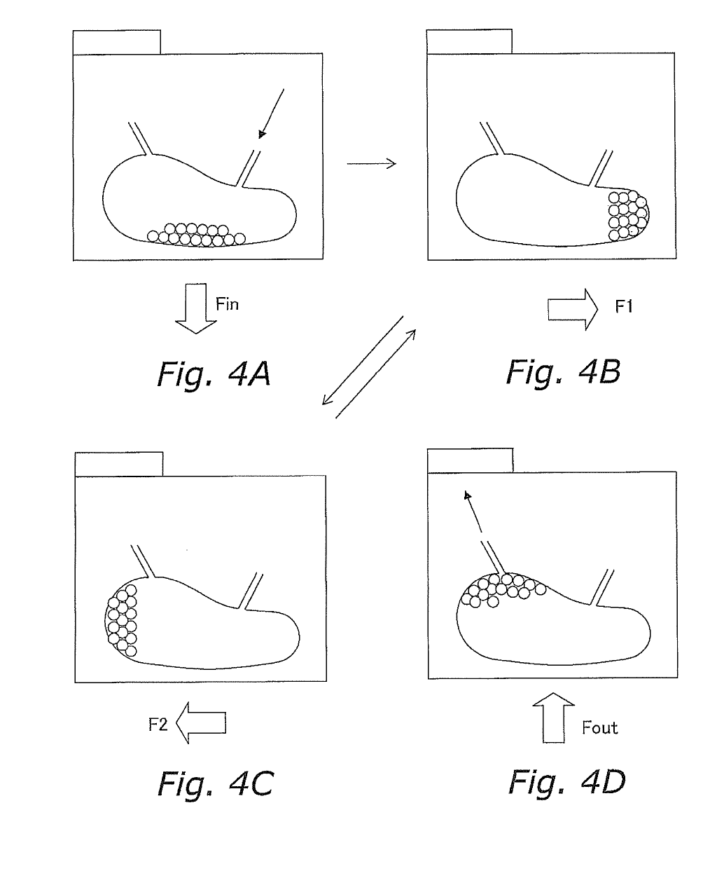

FIG. 4 is an explanatory diagram showing a method for using the microchip 10 of FIG. 1. Here, a case is explained where a granular carrier to which a first recognition substance or a second recognition substance is immobilized is held in advance in the mixing chamber 12. The following method includes a sample introducing step, a first mixing step, second to fourth mixing steps and an ejecting step.

### (4-1) Sample Introducing Step

First, as shown in FIG. 4A, the microchip 10 is rotated in the third rotation direction, and centrifugal force in the direction shown with the arrow Fin in the figure is applied thereto. In this way, the sample in the sample introduction part 11 and the reagent in the preliminary mixing chamber 14 are introduced into the mixing chamber 12. In this way, the target in the sample and the first recognition substance in the mixing chamber 12, or the first recognition substance introduced from the preliminary mixing chamber 14 and the second recognition substance in the mixing chamber 12 are contacted. Contact time of each reacting substance in the mixing chamber 12 is almost the same irrespective of the position within the mixing chamber 12.

### (4-2) First Mixing Step

Next, as shown in FIG. 4B, the microchip 10 is rotated in the first rotation direction, and centrifugal force in the direction shown with the arrow F1 in the figure is applied thereto. In this way, the fluid and the microparticles in the mixing chamber 12 are stirred/mixed. By applying centrifugal force to the liquid mixture in a different direction, the uniformity of the concentration of substance to be detected can be improved. When the angle formed by centrifugal force F1 in the first rotation direction and centrifugal force Fin applied when the sample is introduced into the mixing chamber is closer to 180 degrees, it becomes easier to uniformize the concentration of the reacting substance.

### (4-3) Second to Fourth Mixing Steps

As shown in FIG. 4C, a second mixing step is performed by rotating the microchip 10 in the second rotation direction. In this way, the fluid and the microparticles in the mixing chamber 12 are stirred/mixed. By applying centrifugal force to the liquid mixture in a different direction, the uniformity of the concentration of substance to be detected can be further improved. When the angle formed by centrifugal force F1 caused during the rotation in the first rotation direction and centrifugal force F2 caused during the rotation in the second rotation direction is closer to 180 degrees, it becomes easier to uniformize the concentration of the reacting substance.

Practically, it is necessary to rotate the microchip at least in two different directions when the microparticles and the sample in the mixing chamber are to be mixed by the rotation. It is because the concentration of the liquid mixture cannot be uniformized only by rotation in one direction, which only causes centrifugal force in one direction. Note that there may be three or more rotation axes for the microchip.

Thereafter, a third mixing step is performed by rotating the microchip 10 in the first rotation direction again (FIG. 4B). Further thereafter, a fourth mixing step is performed by rotating the microchip 10 in the second rotation direction again (FIG. 4C). By changing the rotation direction in this way, centrifugal forces F1 and F2 are repeatedly applied, thereby further improving the uniformity of the concentration of the reacting substance in the liquid mixture.

The rotation direction is changed at least once (the aforementioned first mixing step), and the second, third and further mixing steps may be carried out thereafter depending on the viscosity of sample and reagent, the size or weight of the granular carrier, the shape of the mixing chamber 12 and the like. A fifth, sixth and further mixing steps may be performed as necessary.

In the first to fourth mixing steps, the rotation direction for each mixing step is adjusted so that the connection parts of the microchannels 13a and 13b, to the mixing chamber 12 are not included on the wall of the mixing chamber 12 against which the liquid mixture therein is pushed by centrifugal force. The same holds true for a case where there are three or more rotation directions. This is so in order to prevent the liquid mixture from flowing from the mixing chamber 12 to outside.

### (4-4) Ejecting Step

After the completion of mixing, the microchip 10 is rotated in a fourth rotation direction as shown in FIG. 4D. In this way, the liquid mixture is moved from the mixing chamber 12 to the calorimetric reaction part 15. At this time, it is not necessary to move all the liquid mixture in the mixing chamber 12 to the colorimetric reaction part 15. Because the concentration of the reacting part in the liquid mixture is uniform irrespective of the position of the mixing chamber 12, it is enough to move a part of the liquid mixture to the colorimetric reaction part 15. Therefore, the amount of the reagent for the calorimetric reaction can be reduced. Thereafter, the reaction solution that has developed a color in the calorimetric reaction part 15 is introduced into the detection part 16, and the target is detected by analyzing and measuring the reacting substance.

Note that a subsequent treatment to the mixing chamber 12 is not limited to the calorimetric reaction, and detecting, analyzing and measuring treatment. Other necessary functional parts may be provided to the microchip 10 in accordance with the intended use of the microchip 10, and treatments can be carried out accordingly using these functional parts.

### Experimental Example

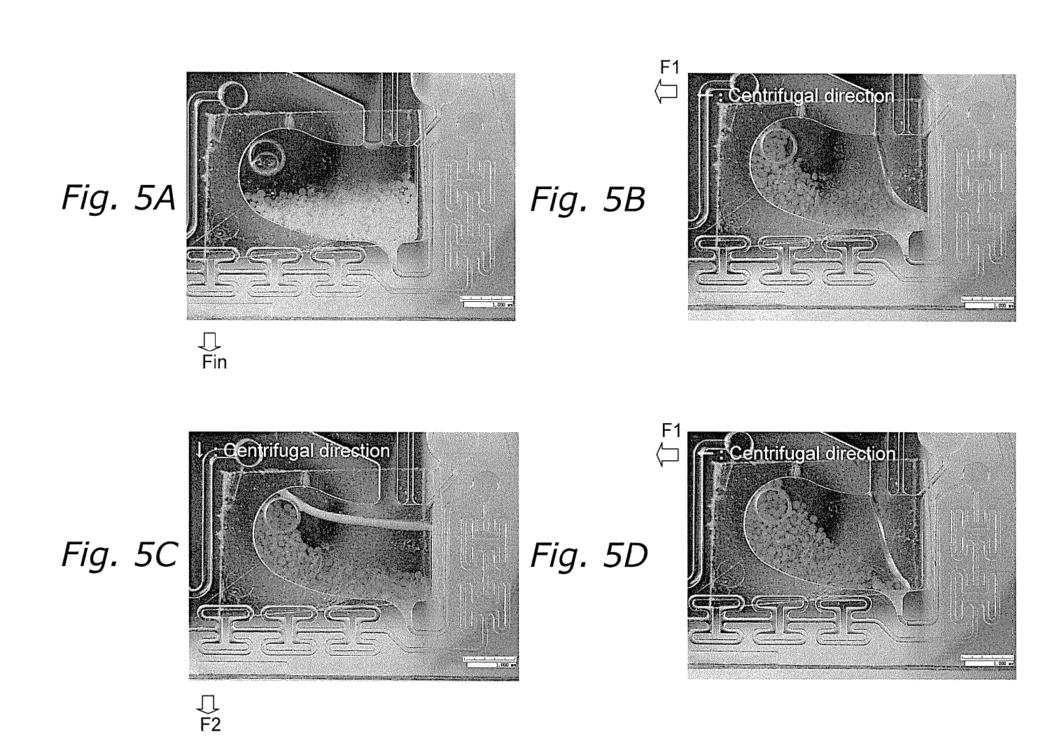

The microchip 10 according to the present invention was prepared, and an experiment was conducted using the prepared microchip 10. FIG. 5 shows photographs showing an experimental example of the microchip 10 of the present invention. In this experiment, Chitopearl was used as a granular carrier, an anti-idiotype antibody as a recognition substance, CRP as a target, and a solution containing CRP which was adjusted with PBS as a sample containing the target. The amount of the sample solution was 12 μL, and the amount of Chitopearl was 10 μL.

FIG. 5A shows a stage where the microchip 10 was rotated in the rotation direction that causes centrifugal force Fin in the direction shown with the arrow in the figure, and the sample was introduced into the mixing chamber 12. At this stage, microparticles positioned on the upper wall side in the figure were reacted with the target among the microparticles.

FIGS. 5B, 5C and 5D each shows a state after the microchip 10 was rotated for 10 seconds in the first rotation direction that causes centrifugal force F1 in the direction shown with the arrow in the figure, in the second rotation direction that causes centrifugal force F2, and again in the first rotation direction, respectively. It can be seen that the reaction of the microparticles with the target progressed every time the rotation direction is changed. Also, it can be seen that reacted microparticles and unreacted microparticles among the microparticles were distributed evenly.

By contacting the microparticles and the sample using centrifugal force, the contact time of the target and the first recognition substance, or the contact time of the first recognition substance and the second recognition target will be equalized irrespective of the position in the mixing chamber 12. Further, because the microparticles and the sample are mixed evenly in the mixing chamber 12 by changing the rotation direction, the concentration of the reactant in the liquid mixture is uniformized irrespective of the position of the mixing chamber 12.

When the liquid mixture having the uniform concentration as described above is obtained, it is enough to extract a part of the liquid mixture and use the same for the process subsequent to the mixing process without the need of using all the liquid mixture. Therefore, the solution introduced into a part used for a process subsequent to the mixing process can be reduced, and the whole microchip 10 can be miniaturized. An example of a part used for a process subsequent to the mixing process may be a second mixing chamber and the detection part 16. Also, when a further channel for mixing is provided in the downstream of the mixing chamber 12, the whole microchip 10 can be miniaturized by shortening or omitting that channel.

### Second Embodiment

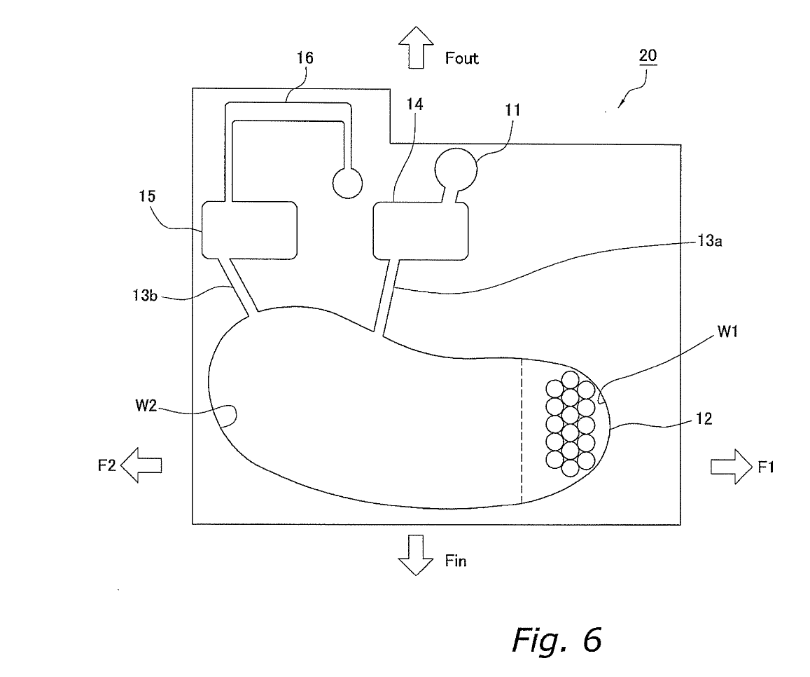

FIG. 6 is a plan view of a microchip 20 according to a second embodiment. The same reference numerals are assigned to the elements that have the same functions as the microchip 10 described in the first embodiment. In the microchip 20 of the present embodiment, the diameter of the microchannels 13 is formed smaller than the diameter of the microparticles in the mixing chamber 12 at the connection parts to the mixing chamber 12. In this way, the microparticles in the mixing chamber 12 are prevented from flowing out to the microchannels 13 no matter from which direction centrifugal force is applied to the microchip 10. Other configurations of the microchip 20, a treatment process using the microchip 20, a method for using the microchip 20 and the like in the present embodiment are the same as those of the first embodiment described earlier.

### INDUSTRIAL APPLICABILITY

The present invention can be applied for a clinical analysis chip, an environmental analysis chip, a gene analysis chip, a protein analysis chip, a sugar chain chip, a chromatograph chip, a cell analysis chip, a pharmaceutical screening chip, a biosensor and the like used in the fields of medical care, food, pharmaceuticals and the like.

1. A microchip for treating a sample using centrifugal force, comprising:
a mixing chamber for mixing microparticles and the sample,
the miciroparticles being prepared by immobilizing a first recognition substance or a second recognition substance to a granular carrier,
the first recognition substance recognizing a target in the sample, and
the second recognition substance recognizing the first recognition substance; and
a microchannel connected to the mixing chamber,
wherein the mixing chamber holds the microparticles in a way that the microparticles are flowable.

2. The microchip according to claim 1, wherein a diameter of the microchannel at a connection part of the microchannel to the mixing chamber is formed greater than a diameter of the microparticles in the mixing chamber, and
the microchip further comprises an outflow prevention pillar for preventing the microparticles from flowing out from the mixing chamber, the outflow prevention pillar being formed at the connection part.

3. The microchip according to claim 1, wherein a diameter of the microchannel at a connection part of the microchannel to the mixing chamber is formed smaller than the diameter of the microparticles.

4. The microchip according to any of claims 1 to 3, wherein a part of a wall surface of the mixing chamber is curved along a predetermined rotation direction.

5. The microchip according to any of claims claim 1, wherein
the microchannel is connected to a wall surface at a point other than where a pressure of a content in the mixing chamber is received when mixing is carried out therein.

6. The microchip according to claim 1, wherein
the microchannel is connected at a position in a way that a liquid mixture in the mixing chamber does not leak when the microchip is rotated in a predetermined first rotation direction and a predetermined second direction.

7. The microchip according to claim 1, wherein
the granular carrier is polysaccharide-based granular gel, latex particles or magnetic beads.

8. A method of using the microchip according to claim 1, comprising the step of mixing the microparticles and the sample in the mixing chamber by rotating the microchip in a first rotation direction and thereafter by rotating the microchip in a second rotation direction that is different from the first rotation direction.

9. The method of using the microchip according to claim 8, further comprising the steps of:
ejecting a part of a liquid mixture in the mixing chamber through any of microchannels by rotating the microchip in a third rotation direction that is different from the first rotation direction or the second rotation direction, and
analyzing a target in the sample using the part of the liquid mixture ejected in the step of ejecting.

10. The method of using the microchip according to claim 8 or 9, further comprising the step of repeating the step of mixing.

11. The method of using the microchip according to claim 8, wherein the first rotation direction and the second rotation direction are adjusted so that a connection part of the microchannel to the mixing chamber is not included on a wall surface against which the liquid mixture in the mixing chamber is pushed by centrifugal force in the step of mixing.

12. The method of using the microchip according to claim 9, wherein the first rotation direction and the second rotation direction are adjusted so that a connection part of the microchannel to the mixing chamber is not included on a wall surface against which the liquid mixture in the mixing chamber is pushed by centrifugal force in the step of mixing.
